(19) United States
(12) Patent Application Publication
(10) Pub. No.: US 2008/0225466 A1
(43) Pub. Date: Sep. 18, 2008

(54) INFORMATION HANDLING SYSTEM CHASSIS FORMED OF BEAMS AND EXTERIOR PANELS

(75) Inventors: Daniel S. Carr, Round Rock, TX (US); James Don Curlee, Round Rock, TX (US); Bradley A. Jackson, Pflugerville, TX (US)

Correspondence Address: HAYNES AND BOONE, LLP, 901 Main Street, Suite 3100, Dallas, TX, 75202, US

(73) Assignee: DELL PRODUCTS L.P., Round Rock, TX (US)

(21) Appl. No.: 11/686,633

(22) Filed: Mar. 15, 2007

(51) Int. Cl. H02B 1/00; B21D 47/00

(52) U.S. Cl. 361/600; 29/897

(57) ABSTRACT

An information handling system (IHS) chassis includes a first subassembly including a first panel attached to a first plurality of beams. A second similarly constructed subassembly is positioned parallel to the first subassembly. First and second end panels are attached to the first and second subassemblies so that the first and second subassemblies are maintained parallel. A plurality of side beams including a first side panel are interconnected between the first and second subassemblies so that all the panels and beams define a cavity having an open side. An access panel is movably attached to the open side. All of the panels used in the chassis construction are exterior panels.

### BACKGROUND

The present disclosure relates generally to information handling systems, and more particularly to a chassis for such systems.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Current chassis structures and assembly methods comprise a metal base structure having multiple sides. Outer aesthetic plates and covers, usually metal or plastic are fabricated over the metal base.

For a larger chassis, excessive weight is a concern. Therefore, the current chassis structures and assembly methods are not suitable for larger chassis of an acceptable weight.

Accordingly, it would be desirable to provide a large chassis absent the disadvantages found in the prior methods discussed above.

### SUMMARY

According to one embodiment, an information handling system chassis includes a first subassembly and a second subassembly. Each subassembly is formed by a panel attached to a plurality of beams. First and second end panels are attached to the first and second subassemblies in a fixture. Thereafter, a plurality of exterior side panels are attached.

### BRIEF DESCRIPTION OF THE DRAWINGS

FIG. 1 is a diagrammatic view illustrating an embodiment of an information handling system.

FIGS. 2A, 2B, 3A and 3B are perspective views illustrating an embodiment of subassemblies formed of beams and exterior panels.

FIG. 4 is a perspective view illustrating an embodiment of subassemblies and end panels in a fixture.

FIG. 5 is a perspective view illustrating an embodiment of a partially assembled chassis shell.

FIG. 6 is a perspective view illustrating an embodiment of a further assembled partial chassis.

FIG. 6A is a perspective view illustrating an embodiment of a subassembly formed of beams and an exterior side panel.

FIG. 7 is a perspective view illustrating an embodiment of an assembled chassis having a removable access panel.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

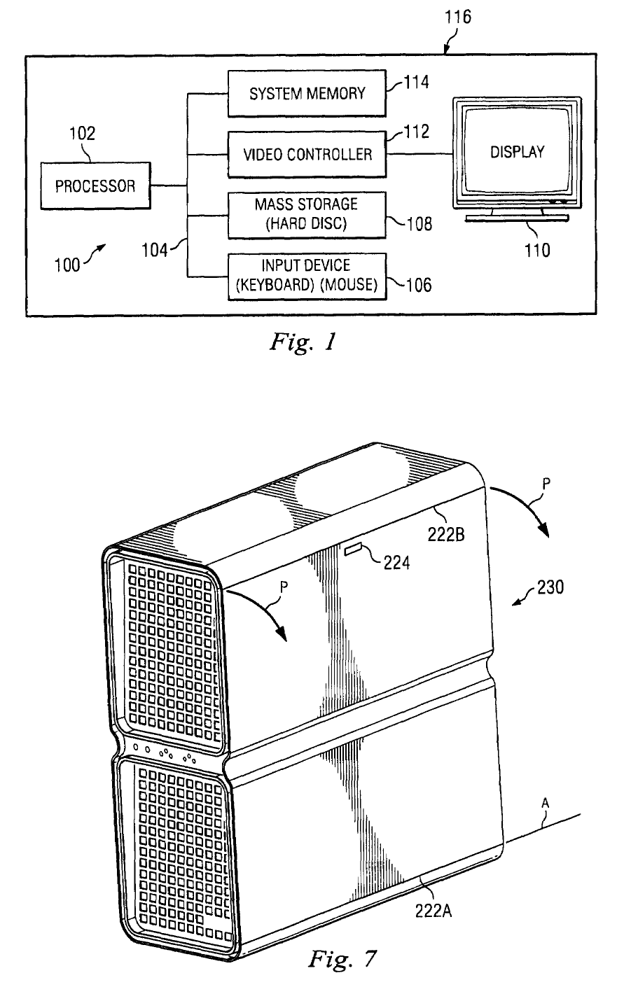

In one embodiment, IHS 100, FIG. 1, includes a microprocessor 102, which is connected to a bus 104. Bus 104 serves as a connection between microprocessor 102 and other components of computer system 100. An input device 106 is coupled to microprocessor 102 to provide input to microprocessor 102. Examples of input devices include keyboards, touchscreens, and pointing devices such as mouses, trackballs and trackpads. Programs and data are stored on a mass storage device 108, which is coupled to microprocessor 102. Mass storage devices include such devices as hard disks, optical disks, magneto-optical drives, floppy drives and the like. IHS 100 further includes a display 110, which is coupled to microprocessor 102 by a video controller 112. A system memory 114 is coupled to microprocessor 102 to provide the microprocessor with fast storage to facilitate execution of computer programs by microprocessor 102. In an embodiment, a chassis 116 houses some or all of the components of IHS 100. It should be understood that other buses and intermediate circuits can be deployed between the components described above and microprocessor 102 to facilitate interconnection between the components and the microprocessor. In one embodiment, a tower, type chassis 230 may be provided, FIG. 7.

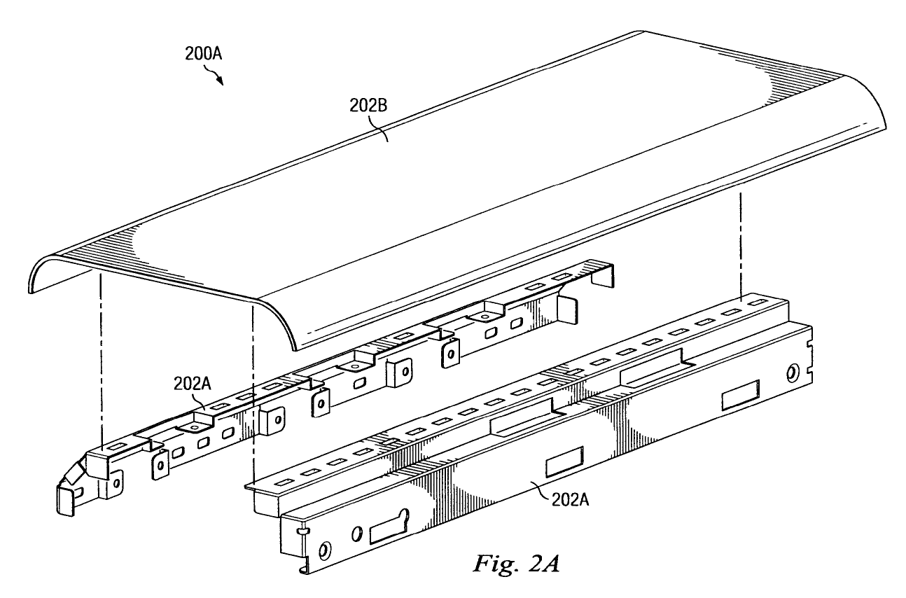

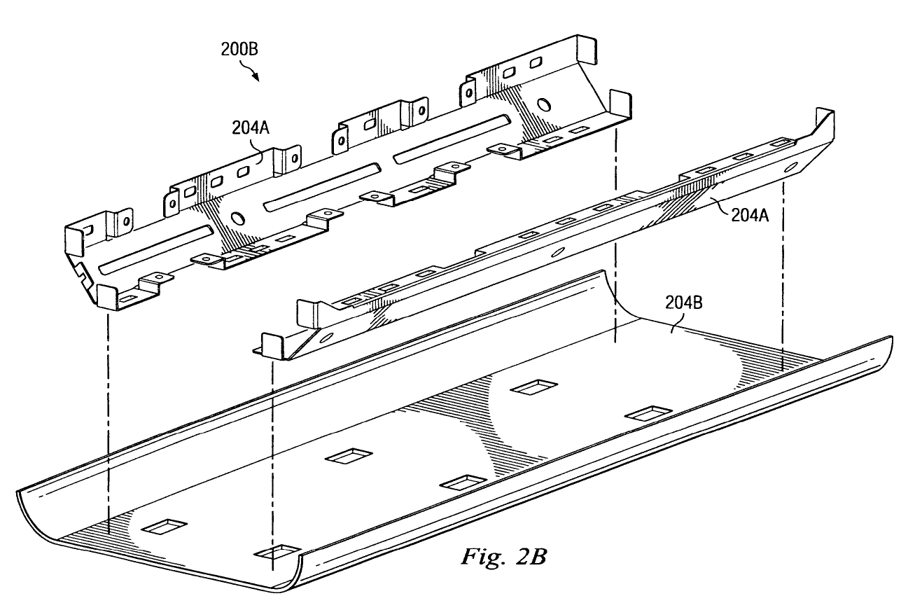

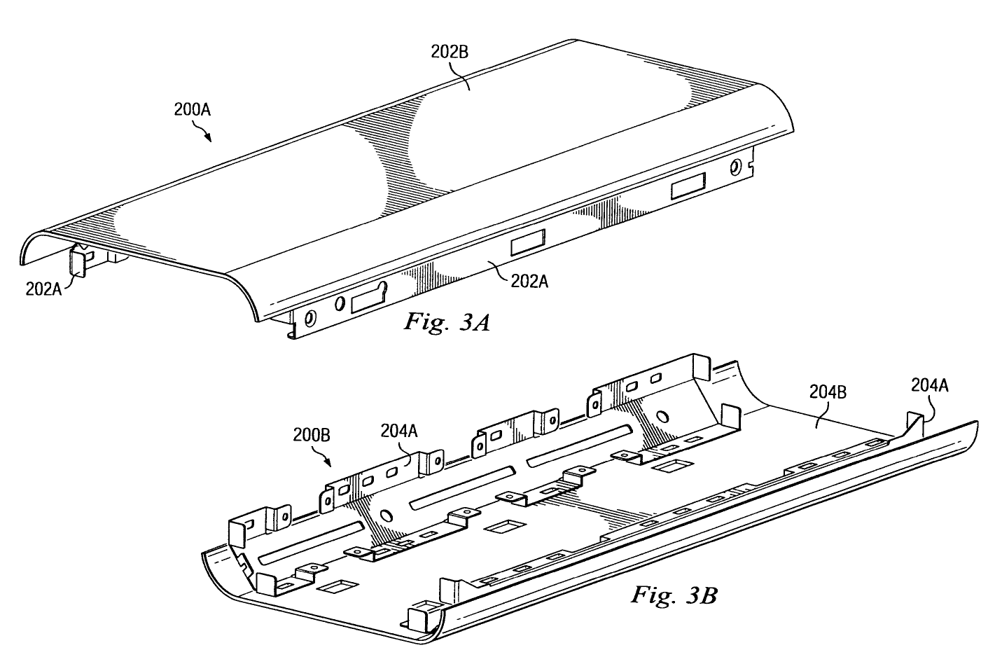

FIGS. 2A and 2B are perspective views illustrating an embodiment of a subassembly 200A including a plurality of beams 202A and an exterior chassis panel 202B, and respectively, a subassembly 200B including a plurality of beams 204A and an exterior chassis panel 204B. FIGS. 3A and 3B are perspective views illustrating an embodiment of subassemblies 200A and 200B having their respective beams and exterior panels attached by a suitable adhesive.

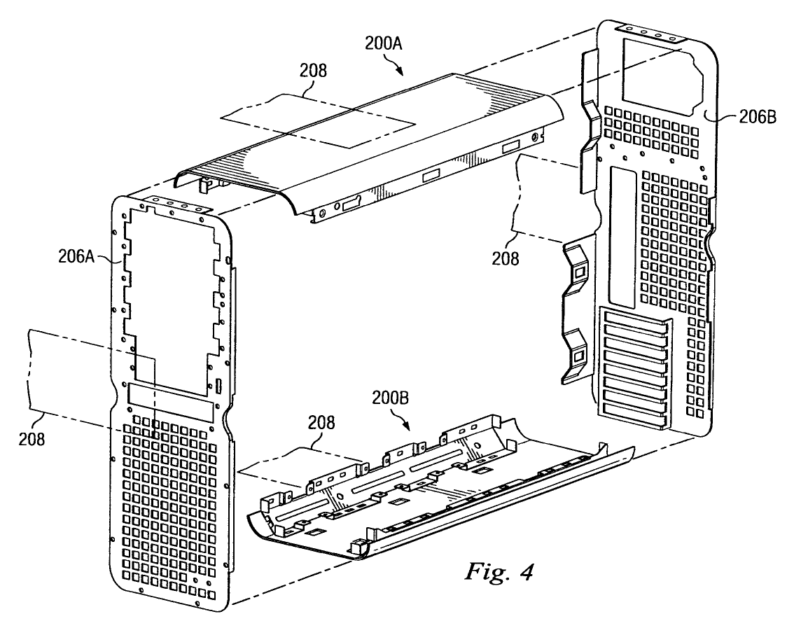

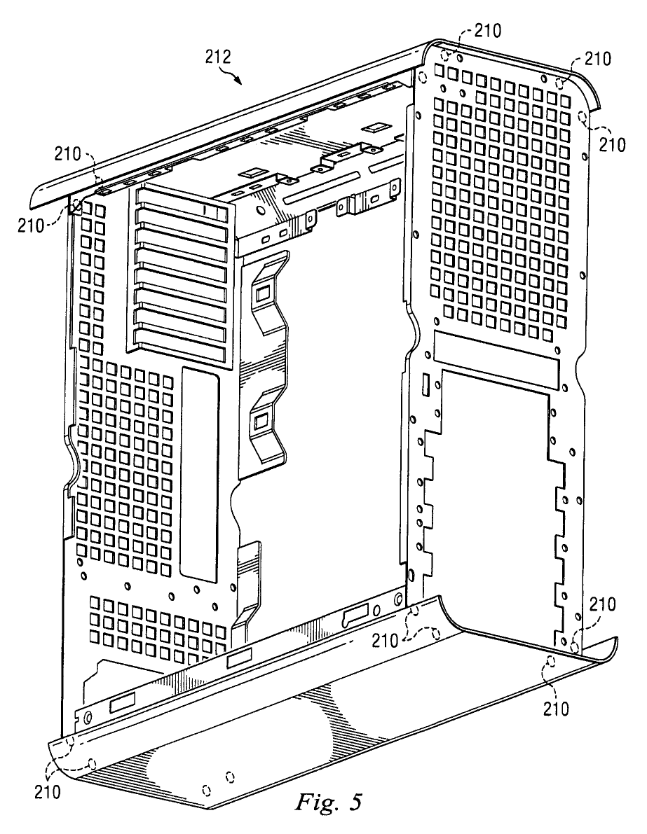

The subassemblies 200A and 200B are assembled, FIG. 4, with a pair of exterior end panels 206A, 206B in a suitable fixture 208 which is operable to receive the subassemblies 200A, 200B and the end panels 206A, 206B, and position the subassemblies 200A, 200B spaced apart from each other and parallel to each other. The fixture 208 is also operable to position the end panels 206A, 206B adjacent opposite ends of the subassemblies 200A, 200B. The fixture 208 is further operable to move the subassemblies 200A, 200B and the end panels 206A, 206B into contact, at which time the end panels 206A, 206B are attached to the subassemblies 200A, 200B by a suitable attachment means and method which will retain the subassemblies 200A, 200B and end panels 206A, 206B affixed. Such means and methods may include adhesives, screws, rivets, welds and dimples formed by compressing abutting pieces together. FIG. 5 illustrates the subassemblies 200A, 200B and the end panels 206A, 206B affixed at points 210, some of which are illustrated, and removed from the fixture 208, and thus forming a partial chassis shell 212.

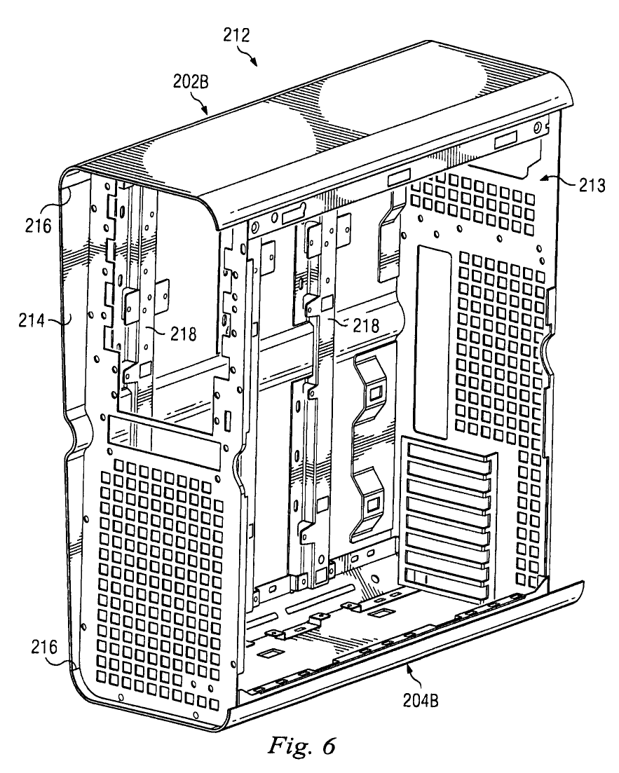

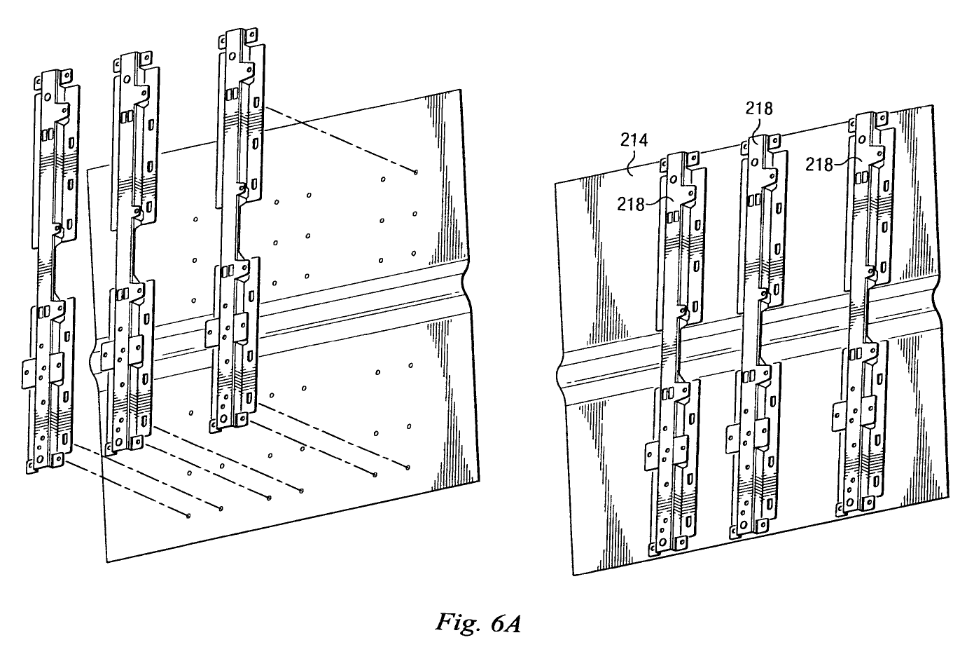

Because the fixture 208 maintains the subassemblies 200A, 200B parallel, as discussed above, an external side panel 214 can be attached to the shell 212 having the aesthetic advantage of close tolerance aligned seams 216, FIG. 6, where the external side panel 214 meets the panels 202B and 204B. Side panel 214 is provided with structural strength by means of plurality of beams 218. The side panel 214 and beams 218 may be preassembled, see also FIG. 6A, prior to attachment to shell 212 by a suitable adhesive as discussed above.

The side panel 214 and beams 218 subassembly can then be attached to shell 212 by suitable fasteners to define a cavity 213. In later stages of assembly, a motherboard (not shown) can be attached to beams 218 thus creating a ground path for chassis components throughout the completed chassis resulting in an EMC enclosure.

A final exterior panel 220, which is an access panel, is attached as illustrated in FIG. 7. Panel 220 is attached to pivot along an arc P and about an axis A, parallel to seam 222A, upon release of a latch type attachment 224 adjacent seam 222B. The completed, light weight, large tower type chassis 230 formed of beams and exterior panels is now ready for completion by final assembly of chassis components within the chassis 230.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A method for building a chassis for an information handling system (IHS) comprising:
attaching a first panel to a first plurality of beams to form a first subassembly;
attaching a second panel to a second plurality of beams to form a second subassembly;
placing the first subassembly in an assembly fixture;
placing the second subassembly in the assembly fixture spaced apart from the first subassembly;
positioning first and second end panels in the fixture adjacent opposite ends, respectively, of the first and second subassemblies;
attaching the first and second end panels to the first and second subassemblies; and
attaching a plurality of exterior side panels.

2. The method as defined in claim 1 wherein the first and second panels are exterior panels.

3. The method as defined in claim 1, further comprising:
removing the attached first and second end panels and the first and second subassemblies from the assembly fixture.

4. The method as defined in claim 3, further comprising:
attaching a first one of the side panels to a plurality of first side beams, the first side panel being an exterior panel interconnected between the first panel and the second panel, whereby all the said panels and beams define a cavity having an open side.

5. The method as defined in claim 4, wherein a second one of the side panels is providing an access side panel for attachment to close the open side.

6. The method as defined in claim 1, wherein the first panel and first plurality of beams are attached by an adhesive material.

7. The method as defined in claim 6, wherein the second panel and second plurality of beams are attached by the adhesive material.

8. The method as defined in claim 1, wherein the fixture is operable to retain the first and second panels parallel.

9. An information handling system (IHS) chassis comprising:
a first subassembly including a first panel attached to a first plurality of beams;
a second subassembly parallel to the first subassembly and including a second panel attached to a second plurality of beams;
first and second end panels attached to the first and second subassemblies such that the first and second subassemblies are maintained parallel;
a plurality of side beams, including a first side panel, interconnected between the first and second subassemblies, whereby all the said panels and beams define a cavity having an open side; and
an access side panel attached to the open side.

10. The chassis as defined in claim 9 wherein the first panel and first plurality of beams are attached by an adhesive material.

11. The chassis as defined in claim 10 wherein the second panel and second plurality of beam are attached by an adhesive material.

12. The chassis as defined in claim 9 wherein the first and second panels, and the first side panel are exterior panels.

13. The chassis as defined in claim 9 wherein the first and second end panels are attached to the first and second subassemblies in a fixture.

14. An assembly system for assembling an information handling system chassis, comprising:
a first subassembly having a first panel attached to a first plurality of beams;
a second subassembly having a second panel attached to a second plurality of beams;
an assembly fixture receiving and maintaining the first and second subassemblies spaced apart and in parallel;
the assembly fixture receiving first and second end panels and maintaining the end panels adjacent the first and second subassemblies;
the first and second end panels being attached to the first and second subassemblies within the assembly fixture whereby the first and second subassemblies are maintained in parallel; and
a plurality of exterior side panels.

15. The system as defined in claim 14 wherein the attached first and second end panels and the first and second subassemblies are removed from the assembly fixture.

16. The system as defined in claim 15 further comprising:
a first one of the side panels being attached to a first plurality of side beams, the first side panel and side beams being attached to interconnect between the first and second subassemblies, whereby all the said panels and beams define a cavity having an open side.

17. The system as defined in claim 16 further comprising:
a second one of the side panels being a removable access side panel provided for attachment to close the open side.

18. The system as defined in claim 14 wherein the first panel and first plurality of beams are attached by an adhesive material.

19. The system as defined in claim 15 wherein the second panel and second plurality of beams are attached by an adhesive material.

20. The system as defined in claim 14 wherein all of the panels are exterior panels.
